(19) United States
(12) Patent Application Publication
(10) Pub. No.: US 2011/0052404 A1
(43) Pub. Date: Mar. 3, 2011

(54) SWEPT BLADES WITH ENHANCED TWIST RESPONSE

(76) Inventor: Michael D. Zuteck, Clear Lake Shores, TX (US)

(21) Appl. No.: 12/547,371

(22) Filed: Aug. 25, 2009

(51) Int. Cl. F01D 5/14; B29C 70/22

(52) U.S. Cl. 416/230; 156/242

(57) ABSTRACT

In certain swept turbine blades, unidirectional fibers within the blade shell are applied in a substantially uncurved state relative to an inboard blade axis, rather than curving the unidirectional fabric in the same direction as the blade sweep. By doing so, the angle between a layout axis of the blade and the fibers of the unidirectional fabric increases with increasing distance outboard of the blade root, enhancing the twist response in the outboard region of the swept blade.

### BACKGROUND

1. Field of the Invention

The invention is directed generally to wind turbine blade design.

2. Description of the Related Art

Wind turbine blades typically comprise a blade shell formed from one or more skins, which may themselves be formed from several layers of fabric. Swept blades, particularly swept blades that utilize sweep-twist coupling to shed loads, may benefit from fabrics and uses of fabrics which differ from those traditionally used in the construction of straight blades. In particular, the fabric of a straight blade generally does not need to be significantly curved within the plane of the fabric to accommodate the shape of the blade, while such curvature may be necessary to accommodate certain fabric layouts used in a swept blade. This curvature places additional constraints on the type of fabrics which can be used, but the geometry of swept blades can also be leveraged to provide or amplify a desired response under load though the use of specific fabrics and orientations.

### SUMMARY OF CERTAIN EMBODIMENTS

In one embodiment, a swept wind turbine blade is provided, including a swept blade shell, the swept blade shell including a unidirectional fabric layer, where the unidirectional fabric layer is disposed within the blade shell such that fibers of the unidirectional fabric layer extend in a substantially constant direction over the length of the fabric layer.

In another embodiment, a swept wind turbine blade is provided, including a swept blade shell, the swept blade shell including a first unidirectional fabric section, where fibers of the first fabric section extend in a substantially constant direction over the length of the first fabric section, a second unidirectional fabric section, where fibers of the second fabric section extend in a substantially constant direction over the length of the second fabric section, where at least a portion of the second fabric section is located outboard of the first fabric section, and a transition region between the first and second fabric sections, where the transition region is substantially parallel to the fibers of at least one of the first and second fabric sections.

In another embodiment, a swept wind turbine blade is provided, including a blade shell, the blade shell including a layout axis which sweeps in an aft direction as the layout axis moves outward, a unidirectional fabric section, where a forward angle between the fibers of the unidirectional fabric section and the layout axis increases in an outboard direction of the layout axis.

In another embodiment, a method of fabricating a swept turbine blade is provided, the method including providing at least one swept shell mold, the mold defining at least a root section, a location of maximum chord, a first edge which is at least partially convex, a second edge which is at least partially concave in a region outboard of the location of maximum chord, and positioning at least one unidirectional fabric within the blade mold such that fibers of the unidirectional fabric extend in a substantially constant direction.

### BRIEF DESCRIPTION OF THE DRAWINGS

FIG. 1 is a perspective view of a wind turbine comprising three swept wind turbine blades.

FIG. 2 is a top plan view of a swept wind turbine blade.

FIG. 3 is a cross-sectional view of the swept wind turbine blade of FIG. 2 taken along the line 3-3 of FIG. 2.

FIG. 4 is a top plan view of an alternative swept wind turbine blade comprising a unidirectional fabric oriented substantially parallel to the inboard blade axis.

FIG. 5 is a top plan view of an alternative swept wind turbine blade comprising two types of unidirectional material oriented substantially parallel to the inboard blade axis.

FIG. 6 is a top plan view of an alternative swept wind turbine blade comprising two types of unidirectional material oriented at a forward angle to the inboard blade axis.

### DETAILED DESCRIPTION OF CERTAIN EMBODIMENTS

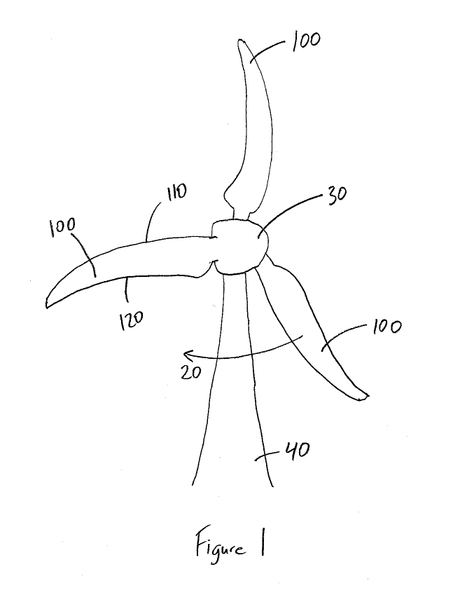

FIG. 1 depicts an exemplary wind turbine 10 comprising three wind turbine blades 100 extending radially from a wind turbine hub 30 mounted on a tower 40. The wind turbine rotates in a direction 20, such that a leading edge 110 of a blade 100 and a trailing edge 120 are oriented as shown in FIG. 1.

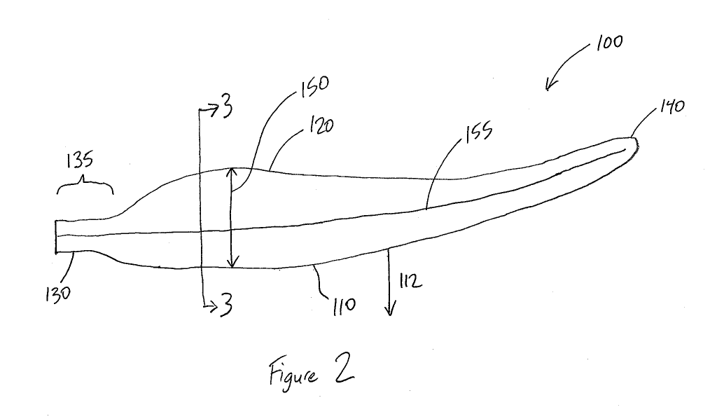

FIG. 2 is a top plan view of an exemplary swept wind turbine blade 100 of FIG. 1. The chord length of the blade is measured from the leading edge 110 to the trailing edge 120 within a twisting plane whose outer part lies near the plane of rotation of the blade 100 in its full power setting. This chord length initially increases as the distance from a blade root 130 increases, until reaching a maximum chord length 150, and then decreases towards a tip 140 of the blade.

It can be seen in FIG. 2 that the tip 140 of the blade is swept backwards, in a direction away from the leading edge 110. The particular shape of the blade may be defined with respect to a layout axis 155, which can be alternatively referred to as the stacking axis. In certain embodiments, the layout axis is defined as a line connecting the centers of area or other chosen reference points (such as percentage of chord from the leading edge) within transverse sections of the airfoil.

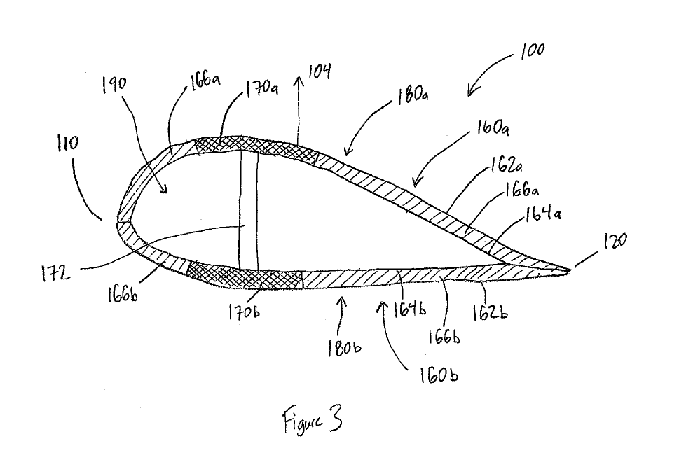

The outer surfaces of typical modern wind turbine blades, also referred to herein as shells, are comprised of an inner skin, an outer skin, and a stabilizing core, as will be described in greater detail with respect to FIG. 3 below. Typically, these skins run from the leading edge 110, or nose of the blade, to the trailing edge 120, or tail of the blade, so that the need to cut or join fabrics at an intermediate point is minimized or avoided, simplifying the construction of the blade. For blades with very large maximum chord lengths, fabric of sufficient width to run from the nose to the tail may be prohibitively difficult and/or expensive to obtain. Thus, production of the fabric covering for the blade length generally requires the joining of fabric sections to form a skin which extends from the nose to the tail of the blade. Of course, it is desirable to minimize the number of such joints. These skins thus typically provide constant mechanical properties, such as the shear and axial modulus of the skin, along their lengths.

In certain embodiments, these skins may comprise multiple types of fabric, so as to provide a resultant structure equipped to handle the loads to which a wind turbine blade will be exposed while in use. Two commonly used types of fabrics are unidirectional fabrics, in which the fibers are oriented in a single direction, and double-biased fabric, in which the fibers are oriented at an angle to one another. By utilizing a combination of unidirectional and double-biased fabrics, a structure can be provided in which the unidirectional fibers bear certain loads, primarily resisting bending of the blade, and the double-biased fabric bears other loads, providing resistance against both bending and twisting.

FIG. 3 is an illustration of an exemplary cross-section of the blade 100 of FIG. 2, taken along the line 3-3 of FIG. 2. The blade 100 comprises an upper shell 160a located on a first or upper surface 180a of blade 100 and a lower shell 160b located on a second or lower surface 180b of blade 100, and an interior stiffening structure comprising spar caps 170a and 170b and shear web 172, each of which are located in or between the upper and lower shells. As noted above, the shells 160a and 160b are composite structures. In particular, shell 160a comprises an outer skin 162a, an inner skin 164a, and a core 166a located therebetween. The outer and inner skins 162a and 164a may comprise fiberglass or another suitable material in an appropriate thickness. The particular thickness and properties of the outer and inner skins 162a and 164a may vary significantly in various embodiments.

The interior stiffening structure, referred to herein as a spar or main spar, comprises the pair of spar caps 170a and 170b extending adjacent the inner skins 164a and 164b of the upper and lower shells, and extending along part of the chord length of the shells, and the shear web 172 extending between the spar caps 170a and 170b. In the illustrated embodiment, the spar caps 170a and 170b are disposed between the inner skin 164a and the outer skin 164b of the adjacent shell sections and of the stiffening cores 166a and 166b. In such an embodiment, the skins may be formed over the spar caps and the core sections to form shells 160a and 160b, and the shells may then be assembled to form a blade. In an alternate embodiment, however, the shells may be formed without the spar caps, such that the inner skin is brought into contact with the outer skin, leaving a gap between the core sections where a spar cap can later be placed.

In the illustrated embodiment, a single shear web 172 extends between the spar caps 170a and 170b to form essentially an I-beam structure. In certain embodiments, some or all of the spar caps 170a and 170b and shear web 172 comprise a high performance material such as carbon fiber, although these structural members may comprise multiple materials at different locations within the structural members.

As noted above, the skins are formed from multiple layers of fabric, which can be placed one upon another in a mold to form a stack of fabric of the desired thickness in the desired blade shell shape. Stiffness of the structure is provided by resin which can be applied to the fabric prior to or during the molding process. Fabric pieces which run from the root of the blade to the tip of the blade, or a substantial section thereof, may provide optimal performance as transition regions between fabric pieces can be avoided over the length of the blade. When forming a swept blade, if fabric is curved in the direction of the blade sweep, portions of the fabric near the leading edge 110 of the blade are stretched to accommodate the blade shape, and the portions of the fabric near the trailing edge 120 of the blade are compressed.

It will be understood that the junctions between the shell sections of the blade may not be located directly at the leading and trailing edges of the blade. Thus, the leading and trailing edges of a mold for a blade shell may not correspond directly to the leading and trailing edges of the eventual blade. Nevertheless, a blade mold for a swept turbine blade will generally have a first edge which is at least partially convex which will form the edge of the blade shell located near the leading edge. Similarly, the blade mold will generally have a second edge which is at least partially concave which will form the edge of the blade shell located near the trailing edge, although other portions of the trailing side of the blade mold may be convex, particularly around the region of maximum chord. The location of maximum chord for a shell section may have a length which is less than the maximum chord length of the finished blade, because at least one of the blade shells may not extend all the way to the leading or trailing edge of the finished blade. In some embodiments, the leading joint between an upper and lower blade shell may be located at the stagnation point, rather than directly at the leading edge. The blade mold will also have other sections, such as a root region to form the base of the blade shell, a location of maximum chord as noted above, a transition section between the root and the location of maximum chord, and an outboard section at greater radius than maximum chord.

Blade skins may comprise a combination of multiple types of fabric, including biased or double-biased fabric, in which the fibers are oriented at angles to the fabric direction, and unidirectional fabric, in which the fibers are oriented in the same direction, usually aligned with the fabric direction. When applied within a swept blade, unidirectional fabric is curved as discussed above to generally follow the curve of the blade, or the curve of the layout axis, such that the fibers are oriented generally parallel to the layout axis of the blade. This arrangement provides the maximum bending resistance, but will place constraints on the type of unidirectional fabrics which can be used in swept blades.

When the unidirectional fabric is curved to be used in a swept blade, the fabric must allow the fibers to shear somewhat relative to one another to accept this curvature. Many unidirectional fabrics are unable to accept the curvature required by some swept blade designs due to the inability to shear in this manner.

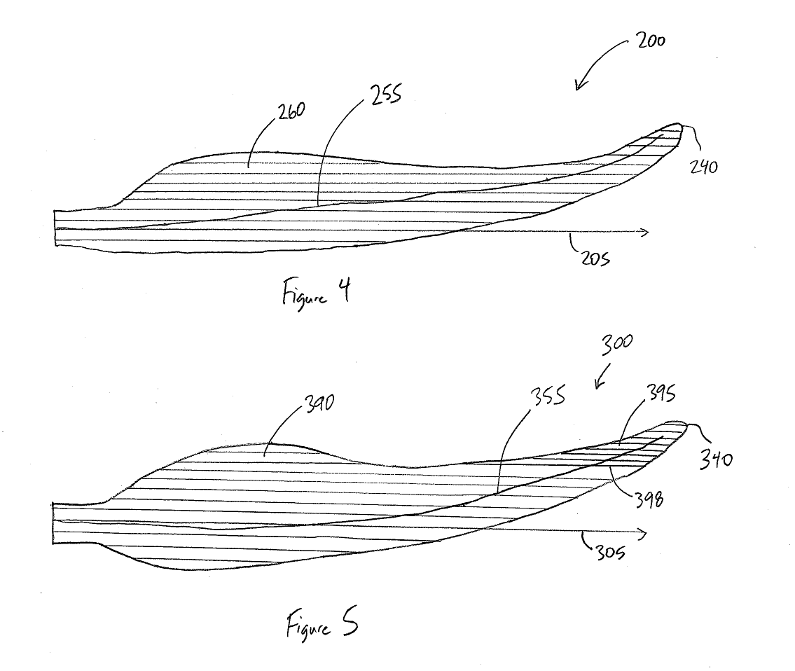

FIG. 4 illustrates an exemplary swept blade 200 in which unidirectional fiber is used, but is not curved to follow the curvature of the blade. The blade 200 comprises a layout axis 255 running from the root 230 of the blade to the tip 240 of the blade, which curves aft as the blade sweeps in the aft direction. The shell 260 comprises unidirectional fabric in which the fibers (the orientation of which are illustrated by the shading) are oriented substantially parallel to the inboard blade axis 205 of the blade 200.

Because the fibers of the unidirectional fabric are oriented in a constant direction across the length of the blade, the fibers in the illustrated embodiment begin substantially parallel to the layout axis 255 near the root 230 of the blade but the layout axis 255 makes a gradually increasing angle with the fibers of the unidirectional fabric as the layout axis approaches the tip 240 of the blade. This increasing angle between the fibers and the layout axis will result in an enhanced twist response near the tip of the blade. This increase in the ability of the tip 240 of the blade to twist in response to thrust loading is particularly helpful when the blade is exposed to very turbulent conditions, as twist of the blade tip can shed loads and decrease the spikes in loading experienced as a turbine blade is exposed to these turbulent conditions.

In particular embodiments, it may be desirable to utilize premium material near the tip of the blade, as reduced thickness and weight of the outboard sections of the blade can have increased effects on its efficiency. Premium material may be a material which has a higher strength to weight or stiffness to weight ratio than that used in inboard sections. For example, it may be desirable to use carbon fiber in outboard sections when fiberglass is used in inboard sections. Any reduction in airfoil thickness or weight at these outboard sections can be highly desirable.

However, difficulties may arise in constructing a transition zone to transfer loads between an inboard material such as fiberglass and a lighter, stronger outboard material such as carbon fiber. In a blade in which the unidirectional fiber orientation tracks the curvature of the blade, a transition zone must be formed to transfer loads from fibers of the inboard material to fibers of the outboard material, and such a transition zone will generally be thick, potentially increasing both the weight and thickness of an outboard section of the blade. In addition to the mechanical tradeoffs of increased weight and thickness, the formation of the transition zone may be more labor-intensive and introduces a possible point of failure. A transition zone may be avoided by forming the entire shell section from the premium material, but use of premium unidirectional material over the entire length of the blade may not be cost effective, as the reduced weight and increased stiffness of premium material may not be necessary in inboard sections of the blade.

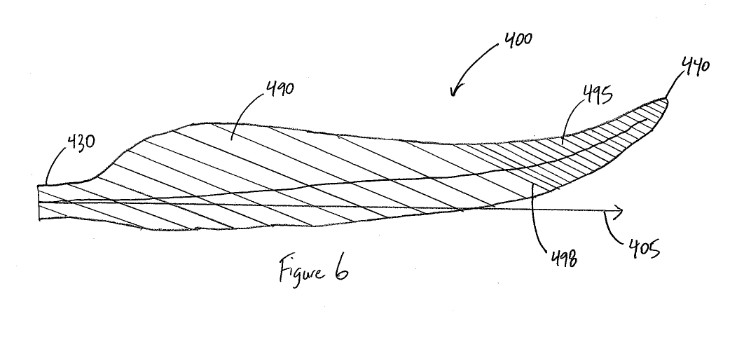

FIG. 5 illustrates a swept blade 300 which utilizes an uncurved unidirectional material to gradually introduce a transition between an inboard material and an outboard material without the need for a bulky transition region. The device is similar to the blade 200 of FIG. 4, and comprises a shell comprising a unidirectional fabric oriented such that the fibers extend substantially parallel to the inboard blade axis 305. The blade 300 is swept aft along a layout axis 355. The blade 300 differs from blade 200 of FIG. 4 in that the shell comprises a first shell section 390 extending from the root 330 of the blade and a second shell section 395 near the tip of the blade. The boundary 398 between the first shell section 390 and the second shell section 395 extends generally parallel to the fibers of the unidirectional fabrics, such that few or none of the fibers are terminated at the boundary.

The shape of the boundaries will be determined based at least in part on the shape and curvature of blade itself, and the outboard material of the second shell section 595 can be introduced at any location, depending on the amount of premium material necessary for a particular blade design. Given the shape of the second blade section 395, the percentage of premium material in the blade shell will gradually increase. This gradual introduction of the premium material allows the load to be taken up slowly by the premium material, reducing the need for a thick transition zone between the inboard material and the outboard material.

In alternate embodiments, the unidirectional fiber may be oriented at an angle to the inboard axis of the blade. FIG. 6 illustrates an embodiment of such a blade 400, which comprises an inboard blade axis 405 and is swept aft along a layout axis 455. Like the blade 300 of FIG. 5, the blade 400 comprises a first shell section 490 of unidirectional material extending from the root 430 of the blade and a second shell section 495 which may comprise a different type of unidirectional material near the tip 440 of the blade. A boundary 498 extends between the first and second shell sections 490 and 495.

The fibers of the unidirectional fabric of both the first and second shell sections 490 and 495 are, oriented parallel to one another, and at an angle slightly forward of the inboard blade axis 405. In contrast to the blade 300 of FIG. 5, it can be seen that the boundary 498 between the first and second shell sections 490 and 495 is oriented at an angle to the blade, reducing the length of the boundary 498. Thus, in an embodiment with an angled unidirectional fabric, the load must be more quickly taken up by the second material, but the shorter boundary may reduce the additional weight added by the boundary 498,

It can also be seen that near the tip 440 of the blade, the forward angle between the fibers of the unidirectional fabric and the layout axis 455 is greater than in the blade 300 of FIG. 5. This increase in the fabric angle will further increase the twist response of the blade tip 440 of the blade when the blade is under thrust loading.

As the forward angle between the unidirectional fabric fibers and the inboard blade axis increases, additional strips of fabric may be required, particularly for larger blades, as the width of the fabric used may become a limiting factor. As additional fabric strips are used, additional transition regions between adjacent fabric strips become necessary, increasing the weight and thickness of the blade shell at these transition regions. Thus, larger angles of unidirectional fabric may not be practical, particularly for larger blades.

In other embodiments, the unidirectional fabric may be angled aft of the inboard blade axis, rather than forward of the inboard blade axis, as discussed with respect to FIG. 10. In still other embodiments, multiple sections of unidirectional fabric need not be oriented such that the fibers are parallel to one another. For example, an inboard section of unidirectional fabric may be oriented more parallel to the inboard blade axis, while an outboard section may be oriented at a different angle, either forward or aft of the inboard blade axis. A fiber line of one of the two fabric sections may still provide a natural transition zone between the two sections, while gradually introducing load not precisely on a particular fiber line of the other fabric section.

Fabrication of a blade such as the blade 300 of FIG. 5 or the blade 400 of FIG. 6 may comprise placing a section of unidirectional fabric within the blade mold such that the fabric remains parallel to or at a substantially constant angle to the inboard blade axis. It will be understood that the unidirectional fabric will generally not remain flat, as the fabric will conform to the three dimensional shape of the mold. If multiple fabric pieces are required to form a single layer of material across the length of the blade, transition regions may be formed in any appropriate manner, including alternating inboard and outboard sections of fabric.

Various other combinations of the above embodiments and methods discussed above are contemplated. It will be understood that the above fabrics and fabric configurations may be used either alone or in conjunction with other fabrics and configurations discussed above and known to persons of ordinary skill in the art. For example, these fabrics and techniques may be used in the fabrication of only one of the skins which forms the blade shell. It is also to be recognized that, depending on the embodiment, the acts or events of any methods described herein can be performed in other sequences, may be added, merged, or left out altogether (e.g., not all acts or events are necessary for the practice of the methods), unless the text specifically and clearly states otherwise.

While the above detailed description has shown, described, and pointed out novel features as applied to various embodiments, various omissions, substitutions, and changes in the form and details of the device of process illustrated may be made. Some forms that do not provide all of the features and benefits set forth herein may be made, and some features may be used or practiced separately from others

What is claimed is:

1. A swept wind turbine blade, comprising:
a swept blade shell, the swept blade shell comprising a unidirectional fabric layer, wherein the unidirectional fabric layer is disposed within the blade shell such that fibers of the unidirectional fabric layer extend in a substantially constant direction over the length of the fabric layer.

2. The blade of claim 1, wherein the blade comprises a layout axis, and wherein an angle between the layout axis and the fibers of the unidirectional fabric layer increases in an outboard direction.

3. The blade of claim 1, wherein the fibers of the unidirectional fabric layer are oriented in a direction substantially parallel to the inboard axis of the blade.

4. The blade of claim 1, wherein the fibers of the unidirectional fabric layer are oriented at forward angle to the inboard axis of the blade.

5. The blade of claim 1, wherein the fibers of the unidirectional fabric layer are oriented at an aft angle to the inboard axis of the blade.

6. The blade of claim 1, additionally comprising:
a second unidirectional fabric layer, wherein at least a portion of the second unidirectional fabric layer is located outboard of the first unidirectional fabric layer; and
a transition region in which the first unidirectional fabric layer and the second unidirectional fabric layer overlap.

7. The blade of claim 6, wherein fibers of the second unidirectional fabric layer extend in a substantially constant direction over the length of the second unidirectional fabric layer.

8. The blade of claim 7, wherein the transition region is substantially parallel to the fibers of at least one of the first and second unidirectional fabric layers.

9. The blade of claim 7, wherein the fibers of the first and second unidirectional fabric layers extend in substantially the same directions.

10. The blade of claim 6, wherein the first unidirectional fabric layer comprises a first material, and the second unidirectional fabric layer comprises a second material, the first material being different than the second material.

11. The blade of claim 10, wherein the second material has a higher stiffness to weight ratio than the first material.

12. A swept wind turbine blade, comprising:
a swept blade shell, the swept blade shell comprising:
a first unidirectional fabric section, wherein fibers of the first fabric section extend in a substantially constant direction over the length of the first fabric section;
a second unidirectional fabric section, wherein fibers of the second fabric section extend in a substantially constant direction over the length of the second fabric section; wherein at least a portion of the second fabric section is located outboard of the first fabric section; and
a transition region between the first and second fabric sections, wherein the transition region is substantially parallel to the fibers of at least one of the first and second fabric sections.

13. The blade of claim 12, wherein the fibers of the first and second fabric sections extend in substantially the same directions.

14. The blade of claim 12, wherein the first fabric section comprises a first material, and the second fabric section comprises a second material, the first material being different than the second material.

15. The blade of claim 14, wherein the second material has a higher stiffness to weight ratio than the first material.

16. The blade of claim 12, wherein the fibers of the first fabric section extend substantially parallel to an inboard blade axis of the swept blade.

17. A swept wind turbine blade, comprising:
a blade shell, the blade shell comprising:
a layout axis which sweeps in an aft direction as the layout axis moves outward;
a unidirectional fabric section, wherein a forward angle between the fibers of the unidirectional fabric section and the layout axis increases in an outboard direction of the layout axis.

18. The blade of claim 17, wherein the fibers of the unidirectional fabric section are oriented substantially parallel to the inboard blade axis.

19. The blade of claim 17, additionally comprising a second unidirectional fabric section and a transition region between the first and second fabric sections, wherein the transition region is substantially parallel to the fibers of at least one of the first or second fabric sections.

20. The blade of claim 19, wherein the first fabric section comprises a first material, and the second fabric section comprises a second material, the first material being different than the second material.

21. The blade of claim 19, wherein the fibers of the first fabric section and the fibers of the second fabric section are oriented substantially parallel to one another within the transition region.

22. A method of fabricating a swept turbine blade, comprising:
providing at least one swept shell mold, the mold defining at least a root section, a location of maximum chord, a first edge which is at least partially convex, and a second edge which is at least partially concave in a region outboard of the location of maximum chord; and
positioning at least one unidirectional fabric within the blade mold such that fibers of the unidirectional fabric extend in a substantially constant direction.

23. The method of claim 22, wherein the fibers of the unidirectional fabric extend in a direction substantially parallel to an inboard blade axis.

24. The method of claim 22, wherein the fibers of the unidirectional fabric extend at an angle to an inboard blade axis.

25. The method of claim 22, further comprising depositing a second unidirectional fabric, wherein at least a portion of the second unidirectional fabric is located farther from the root section than the first unidirectional fabric.

26. The method of claim 25, wherein overlapping portions of the first and second unidirectional fabrics define a transition region.

27. The method of claim 26, wherein fibers of the first unidirectional fabric and fibers of the second fabric section are oriented substantially parallel to one another within the transition region.

28. The method of claim 25, wherein the second unidirectional fabric comprises a different material than the first unidirectional fabric.
